(19) United States
(12) Patent Application Publication
(10) Pub. No.: US 2009/0322073 A1
(43) Pub. Date: Dec. 31, 2009

(54) FASTENING ASSEMBLY FOR A SHOWER APPARATUS

(76) Inventor: Jeff CHEN, Chiayi (TW)

Correspondence Address: RABIN & Berdo, PC, 1101 14TH STREET, NW, SUITE 500, WASHINGTON, DC, 20005, US

(21) Appl. No.: 12/147,771

(22) Filed: Jun. 27, 2008

(51) Int. Cl. F16L 37/00

(52) U.S. Cl. 285/34

(57) ABSTRACT

A fastening assembly for a shower apparatus has a locating pipe, a fastening element and an interconnecting element. The locating pipe has a through hole and an outer thread. The fastening element is mounted around the locating pipe and has a mounting tube, a head and a mounting hole. The mounting tube is mounted around the locating pipe. The head is formed with the mounting tube. The mounting hole is formed in the fastening element and is screwed with the outer thread. The interconnecting element is mounted in the locating pipe, is connected to the fastening element and has an inserting tube and a connecting panel. The inserting tube is inserted into the locating pipe. The connecting panel is formed with the inserting tube and abuts the head. Therefore, the fastening assembly is mounted on the outlet pipe quickly and efficiently to aid shower installation.

### BACKGROUND OF THE INVENTION

1. Field of the Invention

The present invention relates to a fastening assembly, and more particularly to a fastening assembly for a shower apparatus that can be mounted on a wall quickly.

2. Description of Related Art

A conventional shower apparatus is securely mounted on a wall and is connected to a water source to allow water to spray out of the conventional shower apparatus and has a water pipe, multiple locating holes, a locating panel and multiple fasteners. The water pipe is mounted in the wall and is connected to the water source and has an outer end extending out of the wall The locating holes are formed in the wall around the outer end of the water pipe by a drilling machine. The locating panel is mounted on the wall and has multiple through holes. The through holes are formed through the locating panel and align with the locating holes. The fasteners extend through the through holes of the locating panel and are connected to the locating holes to hold the locating panel on the wall.

However, when attaching the conventional shower apparatus on the wall, the user needs to drill the locating holes in the wall to align with the through holes on the locating panel, and this is time-consuming. Furthermore, the dust will generate when drilling the locating holes in the wall and this will pollute the environment.

To overcome the shortcomings, the present invention tends to provide a fastening assembly for a shower apparatus to mitigate or obviate the aforementioned problems.

### SUMMARY OF THE INVENTION

The primary objective of the present invention is to provide a fastening assembly for a shower apparatus that can be mounted on a wall quickly.

The fastening assembly in accordance with the present invention has a locating pipe, a fastening element and an interconnecting element. The locating pipe has a through hole, a polygonal hole and an outer thread. The outer thread is formed around an external surface of the locating pipe. The fastening element is mounted around the locating pipe and has a mounting tube, a head and a mounting hole. The mounting tube is mounted around the locating pipe. The head is formed with the mounting tube. The mounting hole is formed in the fastening element and is screwed with the outer thread. The interconnecting element is mounted in the locating pipe, is connected to the fastening element and has an inserting tube and a connecting panel. The inserting tube is inserted into the locating pipe. The connecting panel is formed with the inserting tube and abuts the head. Therefore, the fastening assembly is mounted on the outlet pipe quickly and efficiently to aid shower installation.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a fastening assembly for a shower apparatus in accordance with the present invention; and

FIGS. 2 to 4 are sequential operational side views in partial section of the fastening assembly in FIG. 1 being mounted with the shower apparatus on a wall.

### DETAILED DESCRIPTION OF THE PREFERRED EMBODIMENT

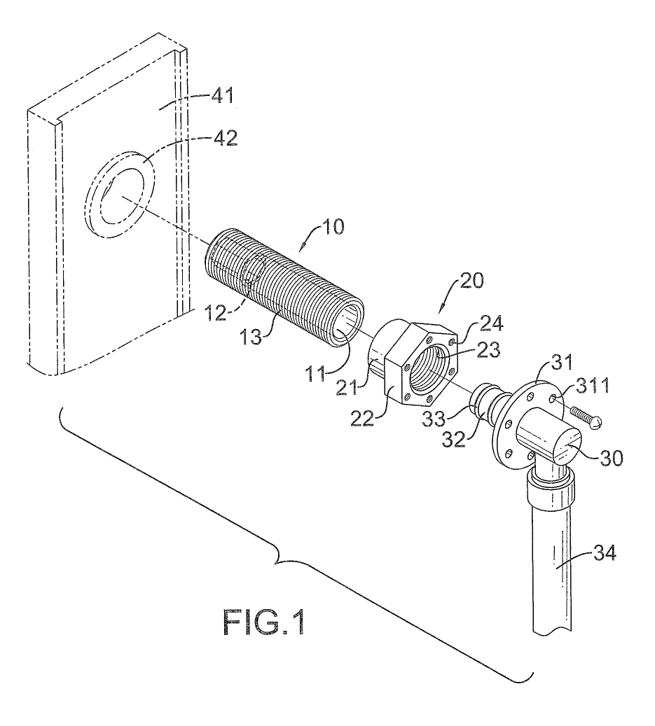

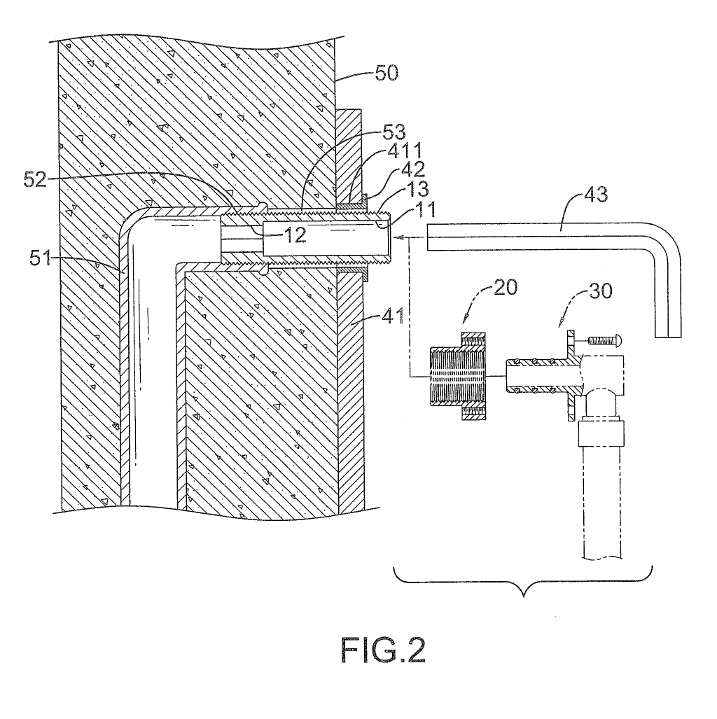

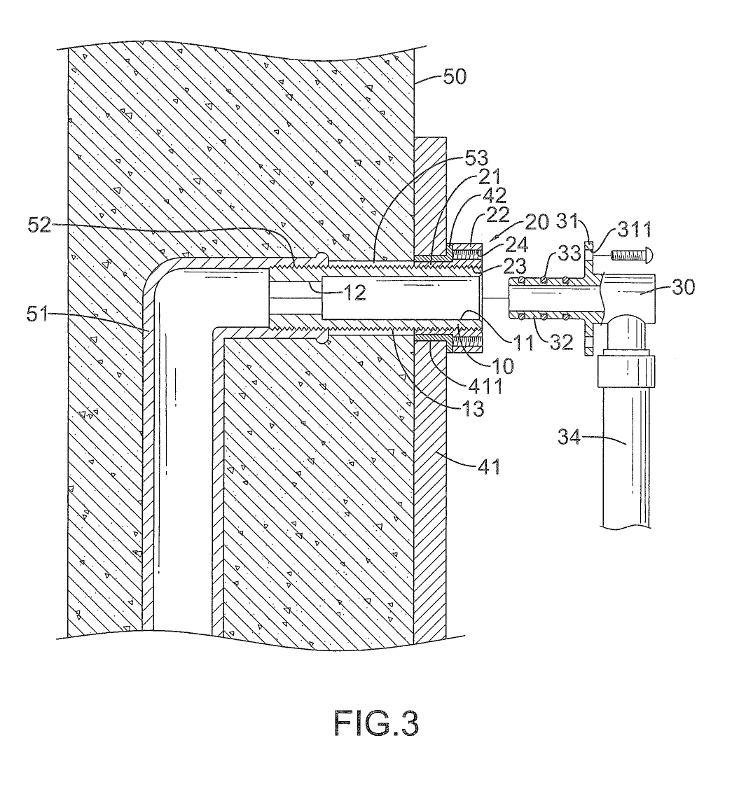

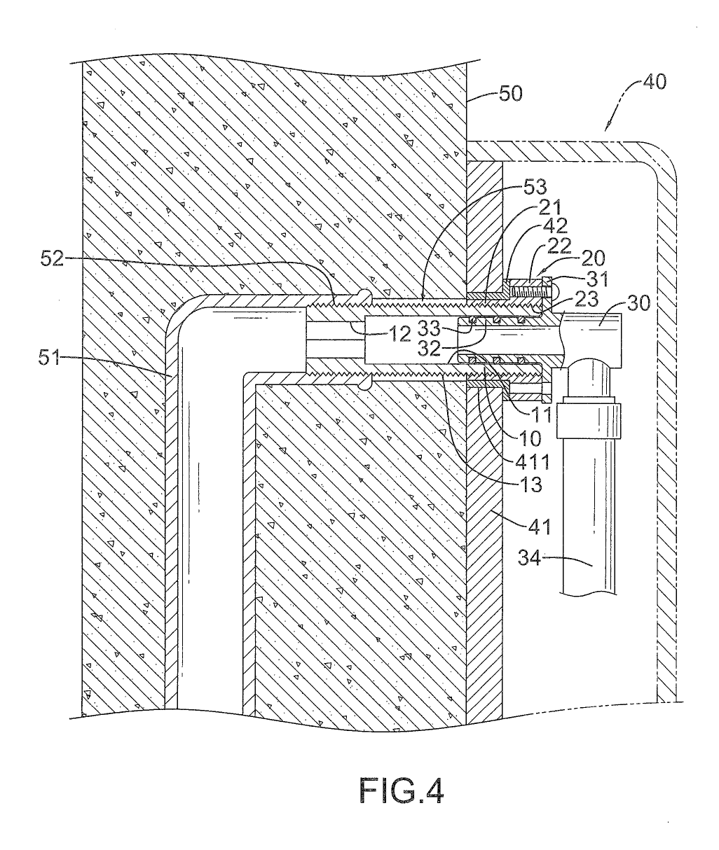

With reference to FIGS. 1 to 4, a fastening assembly for a shower apparatus in accordance with the present invention is mounted on a wall (50) having an external surface, an outlet pipe (51) and an inserting hole (53), is connected to a shower apparatus (40) having a locating panel (41) and a bearing (42), and the fastening assembly comprises a locating pipe (10), a fastening element (20) and an interconnecting element (30).

The outlet pipe (51) is mounted in the wall (50) and has an outer end, an internal surface and an inner thread (52). The inner thread (52) is formed on the internal surface of the outlet pipe (51) in the outer end. The inserting hole (53) is formed through the external surface of the wall (50) and communicates with the outer end of the outlet pipe (51).

The shower apparatus (40) is mounted securely on the wall (50) by the fastening assembly. The locating panel (41) abuts the external surface of the wall (50) and has a locating hole (411). The locating hole (411) is formed through the locating panel (41) and aligns with the inserting hole (53) of the wall (50). The bearing (42) is mounted in the locating hole (411) of the locating panel (41).

The locating pipe (10) is connected to the locating panel (41) of the shower apparatus (40) and the outlet pipe (51) of the wall (50) and has an inner end, an outer end, an external surface, an internal surface, a through hole (11), a polygonal hole (12) and an outer thread (13).

The inner end of the locating pipe (10) extends through the bearing (42) mounted in the locating hole (411) of the locating panel (41) and into the inserting hole (53) of the wall (50), is connected to the outer end of the outlet pipe (51).

The outer end of the locating pipe (10) extends out of the locating panel (41) of the shower apparatus (40).

The through hole (11) is formed in the outer end of the locating pipe (10) and aligns with the outer end of the outlet pipe (51).

The polygonal hole (12) is formed in the inner end of the locating pipe (10) and communicates with the through hole (11) and the outlet pipe (51).

The outer thread (13) is formed around the external surface of the locating pipe (10) and is screwed with the inner thread (52) of the outlet pipe (50) by a fastening tool (43) corresponding to the polygonal hole (12) and being mounted in the polygonal hole (12) via the through hole (11) and rotating the locating pipe (10) relative to the outlet pipe (51).

The fastening element (20) is mounted around the locating pipe (10) to hold the shower apparatus (40) with the wall (50) and has a front end, a rear end, a mounting tube (21), a head (22), a mounting hole (23) and multiple outer setscrew holes (24).

The mounting tube (21) may be a circular tube, is defined in the front end of the fastening element (20), is mounted in the bearing (42) of the shower apparatus (40) and is mounted around the outer end of the locating pipe (10) that extends out of the locating panel (41) and may have a smooth external surface.

The head (22) is defined in the rear end of the fastening element (20), is formed with the mounting tube (21) and is pressed against the bearing (42) of the shower apparatus (40).

The mounting hole (23) is formed through the head (22) and the mounting tube (21), is screwed with the outer thread (13) of the locating pipe (10) and communicates with the through hole (11) and the polygonal hole (12).

The outer setscrew holes (24) are formed in the head (22) around the mounting hole (23).

The interconnecting element (30) is mounted in the locating pipe (10), is connected to the fastening element (20) and has a front end, a rear end, a bottom, an inserting tube (32), a connecting panel (31), a water hole, multiple O-rings (33) and a conduit (34).

The inserting tube (32) is defined in the front end of the interconnecting element (30), is inserted into the locating pipe (11) via the mounting hole (23) of the fastening element (20) and the through hole (11) of the locating pipe (10) and communicates with the outlet pipe (51) of the wall (50).

The connecting panel (31) is defined in the rear end of the interconnecting element (30), is formed with the inserting tube (32) opposite to the locating pipe (10) and abuts the head (22) of the fastening element (20) and has multiple connecting holes (311) and multiple bolts. The connecting holes (311) are formed through the connecting panel (31) and align with the outer setscrew holes (24) in the head (22) of the fastening element (20). Multiple bolts are mounted through the connecting holes (311) and are screwed into the outer setscrew holes (24) to connect the connecting panel (31) of the interconnecting element (30) with the head (22) of the fastening element (20).

The water hole is formed in the connecting panel (31) and the inserting tube (32) and communicates with the locating pipe (10) and the outlet pipe (51) of the wall (50).

Multiple O-rings (33) are mounted around the inserting tube (32) and abut the internal surface of the locating pipe (10) to prevent water flowing out of the fastening assembly between the locating pipe (10) and the fastening element (20).

The conduit (34) is formed on and protrudes from the bottom of the interconnecting element (30) and communicates with the water hole between the connecting panel (31) and the inserting tube (32) to transfer water from the outlet pipe (51).

From the above description, the fastening assembly as described has the following advantages:

1. Users can attach the shower apparatus (40) on the wall (50) by the locating pipe (10), the fastening element (20) and the interconnecting element (30) of the fastening assembly and do not need to drill the locating hole (41) in the wall (50), and the user can attach the shower apparatus (40) to the wall quickly.

2. The fastening assembly can be assembled with the shower apparatus (40) without using a drill so dust is not generated to pollute the environment.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fastening assembly for a shower apparatus comprising
a locating pipe having
an inner end;
an outer end;
an external surface;
an internal surface;
a through hole being formed in the outer end of the locating pipe;
a polygonal hole being formed in the inner end of the locating pipe and communicating with the through hole; and
an outer thread being formed around the external surface of the locating pipe;
a fastening element being mounted around the locating pipe and having
a front end;
a rear end;
a mounting tube being defined in the front end of the fastening element and being mounted around the outer end of the locating pipe;
a head being defined in the rear end of the fastening element and being formed with the mounting tube; and
a mounting hole being formed through the head and the mounting tube, being screwed with the outer thread of the locating pipe and communicating with the through hole and the polygonal hole; and
an interconnecting element being mounted in the locating pipe, being connected to the fastening element and having
a front end;
a rear end;
a bottom;
an inserting tube being defined in the front end of the interconnecting element, being inserted into the locating pipe via the mounting hole of the fastening element and the through hole of the locating pipe;
a connecting panel being defined in the rear end of the interconnecting element, being formed with the inserting tube opposite to the locating pipe and abutting with the head of the fastening element; and
a water hole being formed in the connecting panel and the inserting tube and communicating with locating pipe.

2. The fastening assembly as claimed in claim 1, wherein the mounting tube of the fastening element is a circular tube and has a smooth external surface.

3. The fastening assembly as claimed in claim 2, wherein the interconnecting element further has a conduit being formed on and protruding from the bottom of the interconnecting element and communicating with the water hole between the connecting panel and the inserting tube.

4. The fastening assembly as claimed in claim 3, wherein
the fastening element further has multiple outer setscrew holes being formed in the head around the mounting hole; and
the connecting panel further has
multiple connecting holes being formed through the connecting panel and aligning with the outer setscrew holes in the head of the fastening element; and
multiple bolts being mounted through the connecting holes and being screwed into the outer setscrew holes to connect the connecting panel of the interconnecting element with the head of the fastening element.

5. The fastening assembly as claimed in claim 4, wherein the interconnecting element further has multiple O-rings being mounted around the inserting tube and abutting the internal surface of the locating pipe to prevent water flowing out of the fastening assembly between the locating pipe and the fastening element.

6. The fastening assembly as claimed in claim 1, wherein the interconnecting element further has a conduit being formed on and protruding from the bottom of the interconnecting element and communicating with the water hole between the connecting panel and the inserting tube.

7. The fastening assembly as claimed in claim 1, wherein
the fastening element further has multiple outer setscrew holes being formed in the head around the mounting hole; and
the connecting panel further has
multiple connecting holes being formed through the connecting panel and aligning with the outer setscrew holes in the head of the fastening element; and
multiple bolts being mounted through the connecting holes and being screwed into the outer setscrew holes to connect the connecting panel of the interconnecting element with the head of the fastening element.

8. The fastening assembly as claimed in claim 1, wherein the interconnecting element further has multiple O-rings being mounted around the inserting tube and abutting the internal surface of the locating pipe to prevent water flowing out of the fastening assembly between the locating pipe and the fastening element.

9. The fastening assembly as claimed in claim 2, wherein
the fastening element further has multiple outer setscrew holes being formed in the head around the mounting hole; and
the connecting panel further has
multiple connecting holes being formed through the connecting panel and aligning with the outer setscrew holes in the head of the fastening element; and
multiple bolts being mounted through the connecting holes and being screwed into the outer setscrew holes to connect the connecting panel of the interconnecting element with the head of the fastening element.

10. The fastening assembly as claimed in claim 2, wherein the interconnecting element further has multiple O-rings being mounted around the inserting tube and abutting the internal surface of the locating pipe to prevent water flowing out of the fastening assembly between the locating pipe and the fastening element.

11. The fastening assembly as claimed in claim 3, wherein the interconnecting element further has multiple O-rings being mounted around the inserting tube and abutting the internal surface of the locating pipe to prevent water flowing out of the fastening assembly between the locating pipe and the fastening element.
